(19) United States
(12) Patent Application Publication
(10) Pub. No.: US 2004/0027328 A1
(43) Pub. Date: Feb. 12, 2004

(54) Presentation system

(76) Inventor: Yao-Chi Yang, Taipei County (TW)

Correspondence Address: Raymond Sun, 20 Corporate Park, Suite 155, Irvine, CA, 92606, US

(21) Appl. No.: 10/213,961

(22) Filed: Aug. 7, 2002

(51) Int. Cl. G09G 5/00

(52) U.S. Cl. 345/156

(57) ABSTRACT

A presentation system has a computer, and a projector connected to the computer to receive image information from the computer, and to project one or more images on to the background. The system also includes a pointing unit having a light module that emits a light directed at the background, an image-capturing device that captures the one or more images projected on to the background, with the captured images including the original images together with the light from the pointing unit. The system further includes an image-capturing device connected to the computer to provide thereto information regarding the captured image, and a processor for controlling cursor movement based on the captured images received from the image-capturing device.

### BACKGROUND OF THE INVENTION

1. Field of the Invention

The present invention relates to a presentation system, and in particular, to a system which includes a pointing device, a cursor control function, a projector, and an image capturing device with a computer so as to facilitate a presentation.

2. Description of the Prior Art

When giving a presentation using a conventional projector, an individual previously had to create a plurality of transparencies containing the various pages of the subject matter of the presentation, and then place each page on to the projector one page at a time. This approach was time-consuming and inconvenient. Improvements in technology and software allowed the use of presentation software, TM such as Microsoft Corporation's POWERPOINT™, in a computer so that the software can edit various pages of a presentation document into a single file that can be projected via a projector that was coupled to the computer. However, such software typically required the user to press the “Page Down” and “Page Up” buttons, or to use a pointing device (such as a computer mouse) to control the projection of the different pages of the file. To overcome this inconvenience, a wireless cursor control device was developed to make such projection control even more convenient. In addition, since the individual may have to emphasize key points displayed on the screen during the presentation, the individual typically uses a laser pointer to highlight these points. Unfortunately, it is very difficult and inconvenient to carry, hold and manipulate two separate devices (the wireless cursor control device and the laser pointer) in one hand during a presentation.

A universal presentation device is shown in WO 02/11058, which discloses the integration of a cursor control device with a laser pointer in a single housing. Unfortunately, an individual using this device will need to use the laser pointer function to locate the desired information first, and then turn the housing around to use the cursor control device so as to move the cursor on the display to activate or execute the corresponding command by pressing the button thereon. Such reversing action of the housing to switch between use of the laser pointer and the cursor control device can still be inconvenient.

Thus, there still remains a need for a device that provides convenient use of the pointing and cursor control functions.

### SUMMARY OF THE DISCLOSURE

It is an object of the present invention to provide a presentation system which includes the pointer and cursor control functions.

It is another object of the present invention to provide a presentation system where a user can utilize the light projected by the pointer to control the cursor on the displayed screen of the computer.

In order to accomplish the objects of the present invention, there is provided a presentation system that has a computer, and a projector connected to the computer to receive image information from the computer, and to project one or more images on to the background. The system also includes a pointing unit having a light module that emits a light directed at the background, an image-capturing device that captures the one or more images projected on to the background, with the captured images including the original images together with the light from the pointing unit. The system further includes an image-capturing device connected to the computer to provide thereto information regarding the captured image, and a processor for controlling cursor movement based on the captured images received from the image-capturing device. The cursor control is accomplished through detecting the changing position of the light on the background. Thus, the pointing unit can be used conveniently as both a cursor control device and as a pointer.

### BRIEF DESCRIPTION OF THE DRAWINGS

FIG. 1 is a system diagram of the presentation system according to one embodiment of the present invention.

FIG. 2 is a perspective view of the system of FIG. 1.

FIG. 3 is a schematic diagram of the pointing unit of the system of FIG. 1.

FIG. 4A is a system operation diagram of the presentation system of FIG. 1.

FIG. 4B is an operation diagram of the pointing unit of FIG. 3.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims. In certain instances, detailed descriptions of well-known devices, compositions, components, mechanisms and methods are omitted so as to not obscure the description of the present invention with unnecessary detail.

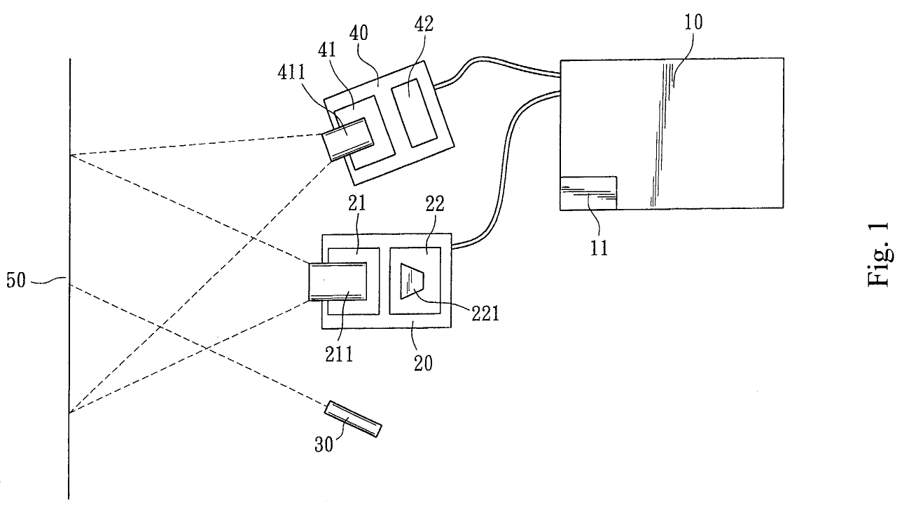

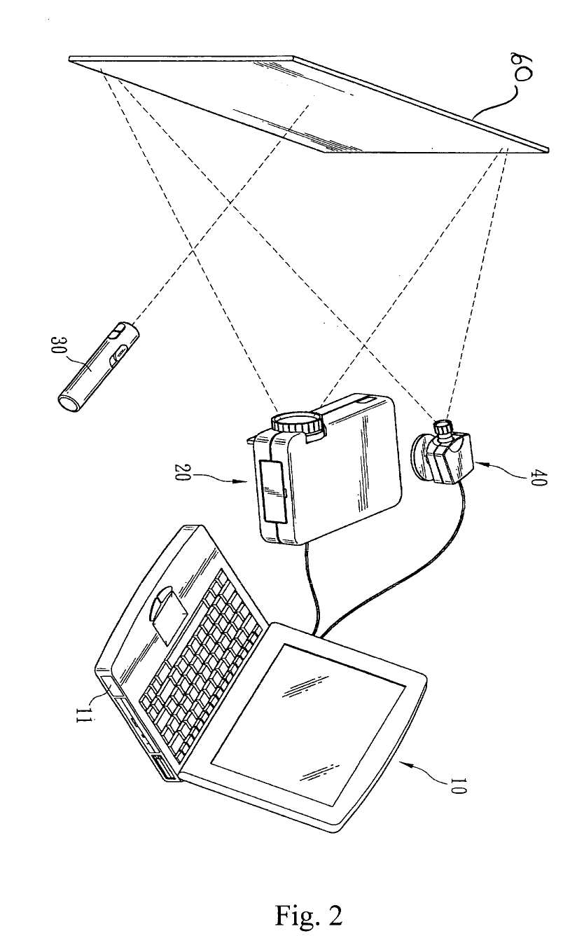

FIGS. 1 and 2 illustrate one embodiment of a presentation system according to the present invention. The presentation system includes a computer 10, a projector 20, a pointing unit 30 and an image-capturing device 40. The computer 10 can be any conventional desk top computer, or notebook computer (as shown in FIG. 2). The computer 10 has a wireless signal receiver 11 located inside or outside the housing of the computer 10.

The projector 20 is connected (e.g., by a wired connection such as a cable) with the computer 10 to receive communication signals representing the images to be displayed by the projector 20. The transfer of information from a conventional computer 10 using software such as POWERPOINT™ to a projector 20 is well-known and will not be described in greater detail herein. The projector 20 can be a conventional projector and includes an optical module 21 and a lighting module 22. The optical module 21 has a lens 211 and the lighting module 22 has a light source 221. The projector 20 will project an image onto a screen 60 based on the information received from the computer 10. In this regard, the projector 20 essentially functions like a display (not shown) of the computer 10 when the projector 20 is connected to the computer 10. The screen 60 can be a discrete screen that is provided to display the images, or can even be a wall of a room or any other background that is suitable for displaying a projected image.

The image-capturing device 40 is also connected (e.g., by a wired connection such as a cable) to the computer 10. The image-capturing device 40 can be embodied in the form of a conventional CCD camera, and includes an optical unit 41 and an image module 42. The optical unit 41 has a lens 411 that functions to focus and capture an image that is then transmitted to the computer 10 for processing and analysis. The image module 42 can be either a charge-coupled device (CCD), a complementary metal oxide semiconductor (CMOS) or any other similar known device.

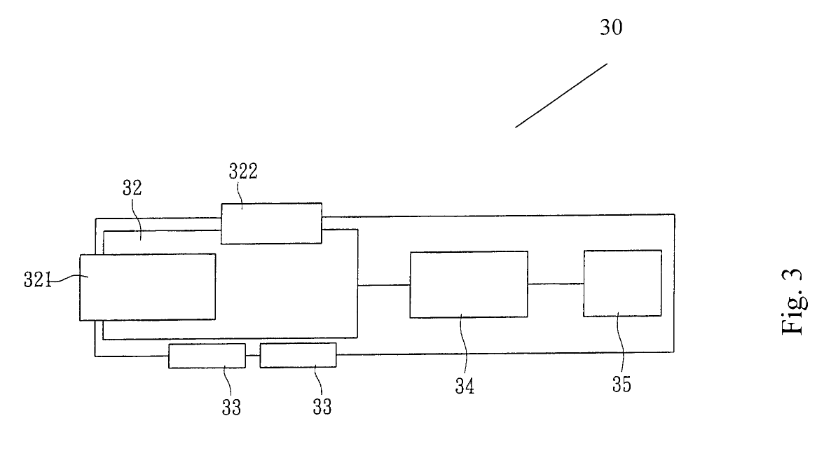

Referring to FIG. 3, the pointing unit 30 has a light module 321 that is coupled to a light switch 322. The light module 321 can be an LED module that emits LED light, or a laser module that emits laser light. The pointing unit 30 also has one or more click buttons 33 that are coupled to a wireless signal transmitter 34 to activate the wireless signal transmitter 34. A power unit 35 (which can contain a battery) is provided in the pointing unit 30 for powering the modules of the pointing unit 30.

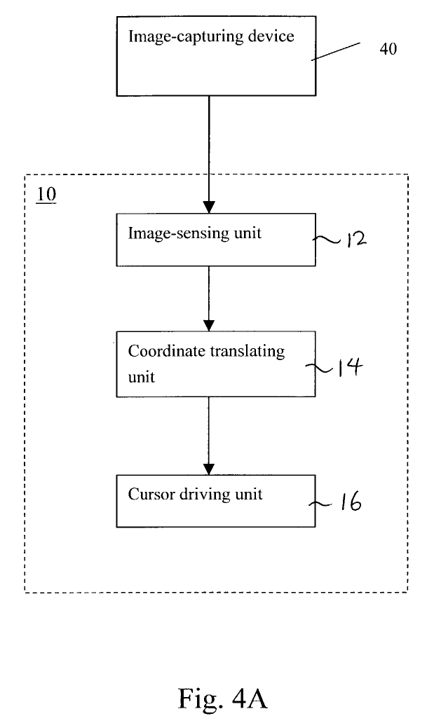

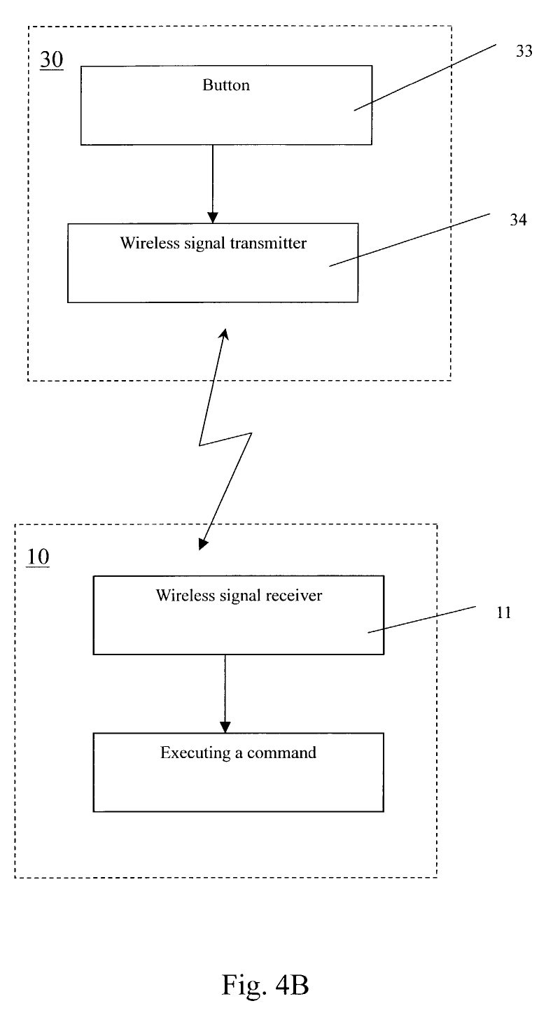

Referring to FIGS. 1 and 2, when a user uses the presentation system to give a presentation, the images to be displayed during the presentation are transferred from the computer 10 to the projector 20, which will project the images on to the screen 60. The image-capturing device 40 is adjusted to focus on to the image 50 on the screen 60, so that the image capturing device 40 will capture the images 50 on the screen 60 and provide information signals corresponding to these images 50 to the computer 10 for processing and analysis. The user can use the pointing device 30 by turning on the switch 322 of the pointing unit 30 as to emit a light via the light module 321 onto the screen 60. The light that is projected onto the image 50 on the screen 60 serves as a cursor control mechanism, since the continuous capture of the image 50 on the screen 60 will include the moving path of the light on the image 50. In other words, even if the same image 50 is being projected by the projector 20, the fact that the light moves around the stationary image 50 will still create different “pictures” that are captured by the image capturing device 40 and provided to the computer 10. These different “pictures” are processed by the computer 10 using known digital signal processing (DSP) techniques to track the movement of the light so as to enable the computer 10 to control cursor movement. For example, referring to FIG. 4A, the computer 10 can have an image-sensing unit 12 that detects the changing location of the light on the screen, a coordinate translating unit 14 that converts the changing location into an X-Y coordinate position, and a cursor driving unit 16 that moves a cursor on the display of the computer 10 correspondingly. In other words, the movement of the light on the screen 60 will be tracked by the location of the cursor on the display.

If the information from the computer 10 contains any command, the user can position the light from the light module 321 on the icon for the command that is displayed on the screen 60, and then simply click the button 33 to activate the wireless signal transmitter 34 so as to transmit a wireless signal to the computer 10. The wireless signal receiver 11 at the computer 10 can receive the wireless signal, and then forward it to the computer 10 so as to execute the corresponding command that is being selected on the screen 60. In other words, the light from the light module 321 acts as a cursor on the display of the computer. Thus, the light from the light module can actually function as both a pointer and a cursor control device.

Thus, the present invention provides a presentation system where the pointing device 30 can be used conveniently as both a cursor control device and as a pointer.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. A presentation system, comprising:
a background;
a computer;
a projector connected to the computer to receive image information from the computer, which is used to project one or more images on to the background;
a pointing unit having a light module that emits a light directed at the background;
an image-capturing device that captures the one or more images projected on to the background, with the captured images including the original images together with the light from the pointing unit, the image-capturing device connected to the computer to provide thereto information regarding the captured image; and
means associated with the computer for controlling cursor movement based on the captured images received from the image-capturing device.

2. The system of claim 1, wherein the computer further includes a wireless signal receiver, and the pointing unit has a wireless signal transmitter and a button, such that actuation of the button will activate the wireless signal transmitter to send a signal to the wireless signal receiver that will cause a corresponding command to be executed by the computer.

3. The system of claim 1, wherein the pointing unit has a switch to turn on or off the light module.

4. The system of claim 1, wherein the computer further includes:
a image-sensing unit coupled to receive the captured images, and to detect the changing location of the light on the background;
a coordinate translating unit coupled to the image-sensing unit to convert the changing location of the light into an X-Y coordinate position; and
a driving unit coupled to the coordinate translating unit to control cursor movement.

5. The system of claim 1, wherein the cursor control accomplished by the means associated with the computer for controlling cursor movement is based on detecting the changing location of the light on the background.

6. A presentation system, comprising:
a background;
a computer;
a projector connected to the computer to receive image information from the computer, which is used to project one or more images on to the background;
means for selectively directing a light at the background;
an image-capturing device that captures the one or more images projected on to the background, with the captured images including the original images together with the light, the image-capturing device connected to the computer to provide thereto information regarding the captured image; and
means associated with the computer for controlling cursor movement based on the captured images received from the image-capturing device.

7. The system of claim 6, wherein the computer further includes a wireless signal receiver, and the light directing means has a wireless signal transmitter and a button, such that actuation of the button will activate the wireless signal transmitter to send a signal to the wireless signal receiver that will cause a corresponding command to be executed by the computer.

8. The system of claim 6, wherein the light directing means has a switch to turn on or off the light.

9. The system of claim 6, wherein the computer further includes:
a image-sensing unit coupled to receive the captured images, and to detect the changing location of the light on the background;
a coordinate translating unit coupled to the image-sensing unit to convert the changing location of the light into an X-Y coordinate position; and
a driving unit coupled to the coordinate translating unit to control cursor movement.

10. The system of claim 6, wherein the cursor control accomplished by the means associated with the computer for controlling cursor movement is based on detecting the changing location of the light on the background.

11. A method of presentation and cursor control, comprising:
projecting an image onto a background;
emitting a light towards the image on the background;
capturing the changing images on the background, which include the image and the light; and
processing the captured images to control the movement of a cursor on a display.

12. The method of claim 11, wherein processing the captured images to control the movement of a cursor on a display includes:
detecting the change in location of the light with respect to the image from one captured image to another captured image.

13. The method of claim 11, further including:
providing a pointing device to emit the light, the pointing device being separate from a computer; and
actuating a switch on the pointing unit to cause the computer to execute a command.
